(19) United States
(12) Patent Application Publication
(10) Pub. No.: US 2014/0335498 A1
(43) Pub. Date: Nov. 13, 2014

(54) GENERATING, ASSIGNING, AND EVALUATING DIFFERENT VERSIONS OF A TEST

(71) Applicant: Apollo Group, Inc., Phoenix, AZ (US)

(72) Inventors: JAYAKUMAR MUTHUKUMARASAMY, Dublin, CA (US); VENKATA KOLLA, Union City, CA (US); PAVAN ARIPIRALA VENKATA, Fremont, CA (US); SUMIT KEJRIWAL, KARNATAKA (IN); NARENDER VATTIKONDA, San Jose, CA (US)

(73) Assignee: Apollo Group, Inc., Phoenix, AZ (US)

(21) Appl. No.: 14/061,747

(22) Filed: Oct. 23, 2013

(30) Foreign Application Priority Data
May 8, 2013 (IN) 2265/CHE/2013

(51) Int. Cl. G09B 7/00

(52) U.S. Cl. CPC G09B 7/00
USPC 434/350

(57) ABSTRACT

Method(s), stored instruction(s), and computing device(s) are provided for automatically generating different subsets of questions and/or automatically assigning the different subsets of questions to different test participants. The computing device(s) store information that includes test questions, test version generation criteria, and test version assignment criteria. The computing device(s) automatically determine, using the test version generation criteria, subsets of test questions that differ from each other by at least one question. The computing device(s) automatically assign, using the test version assignment criteria, subsets of test questions, which differ from each other by at least one question, to different test participants. The computing device(s) then cause administration of at least one of the different versions to at least one of the different test participants.

### BENEFIT CLAIM

This application claims the benefit of priority under 35 U.S.C. §119(a) of the foreign patent application having the application number 2265/CHE/2013, filed with the patent office in India on May 8, 2013, the entire contents of which are hereby incorporated by reference as if fully set forth herein. The applicant(s) hereby rescind any disclaimer of claim scope in the parent application(s) or the prosecution history thereof and advise the USPTO that the claims in this application may be broader than any claim in the parent application(s).

### TECHNICAL FIELD

The technical field relates to generating, assigning, and evaluating different versions of a test.

### BACKGROUND

Tests are administered to people in a variety of settings. For example, teachers may give tests to their students in the form of quizzes, mid-terms, reports, or final exams. Students are often tested on their learning progress as they complete various stages of a course being taught or administered by the teacher. As another example, an organization may give employees proficiency tests or performance tests to evaluate the employees' familiarity with the organization's policies or with the organization's technology. The employee may be self-taught, book-taught, taught by an electronic course offering, or may learn on the job. In yet another example, professionals may take tests to gain certifications in a field of expertise. Tests may also be administered by a test administrator to learn something about the test participant, such as experimental tests or personality tests, without necessarily having correct or incorrect answers.

In most circumstances, an administrator, such as a teacher or another person responsible for a group of test participants, may manually prepare and administer a single version of a test to the group of test participants. Alternatively, the administrator may manually prepare different versions of a test. Different versions are versions that differ by at least one question or have at least two of the same questions in a different order.

The administrator may administer these different versions to different groups of people. For example, a first version of the patent bar exam is administered to morning test-takers, and a second version of the patent bar exam is administered to evening test-takers. The administrator may then evaluate the results of the test to learn something about the test participants, such as whether the participants are proficient in tested topic(s).

When a new teacher takes over teaching a course, the new teacher may use the materials and tests prepared by a previous teacher of the course or may prepare new materials and tests. There is very little empirical data about the effectiveness of teaching materials and tests, and, accordingly, techniques for improving these materials and tests are generally speculative rather than data driven.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates an example system for automatically generating versions of a test and automatically assigning the versions to participants.

FIG. 2 illustrates an example system for automatically assigning versions of a test to participants and analyzing participant responses on the versions of the test.

FIG. 3 illustrates an example interface for analyzing responses of participants on versions of a test.

FIG. 4 illustrates an example process for automatically determining different subsets of test questions.

FIG. 5 illustrates an example process for automatically assigning different subsets of test questions to different participants.

FIG. 6 illustrates an example computer system for performing various embodiments described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Described herein are data driven approaches for generating, assigning, and/or evaluating different versions of a test. In various embodiments, method(s), stored instruction(s), and/or computing device(s) are provided for automatically generating different subsets of questions and/or automatically assigning the different subsets of questions to different test participants. The computing device(s) store information that includes test questions, test version generation criteria, and/or test version assignment criteria. The computing device(s) automatically determine, using the test version generation criteria, subsets of test questions that differ from each other by at least one question. The computing device(s) automatically assign, using the test version assignment criteria, subsets of test questions, which differ from each other by at least one question, to different test participants. The computing device(s) then cause administration of at least one of the different versions to at least one of the different test participants.

Using the test version generation interface, an instructional developer and designer (IDD) may design a course curriculum well in advance of a course offering. At that time, the IDD might not have all of the questions ready for all of the test variations. Question versions, versions of question parts, and/or test versions may be added at a later time into virtual containers identified by virtual test identifiers, virtual question identifiers, and/or virtual question-part identifiers.

Once determined on-the-fly or retrieved from storage, the subset of test questions may be administered to a test participant. For example, a student may take a version of the test that includes the subset of test questions but not other test questions, such as questions belonging to other test version(s), from a question bank. The student's test results may be compared with other students' test results. For example, a response analysis module may score student responses on each question and group the scores on a test-by-test basis or question-by-question basis such that different versions of a test or different versions of a question or question part within the different versions of the test may be compared to each other.

### Topics and Concepts

In one embodiment, an electronic test content repository or question bank stores information about individual test questions, parts of test questions such as question stems or choices, test versions or test samples that include test questions, test templates that include placeholders for interchangeable test questions or parts of test questions, and/or any other test content that could be used to generate a version of a test. The test content may be organized by topics and concepts within the topics.

A topic is a category of test content, and categories may be provided with varying degrees of specificity from general to specific. For example, a general test topic is “math,” a more specific test topic is “algebra,” and an even more specific test topic is “applying the quadratic formula.” Concept(s) are any sub-category of a topic, and the same concept may fall under different topics. In the example, two concepts within the test topic may be “finding real roots” and “finding imaginary roots.” In the example, different questions may test an ability of the test participant to find real roots and/or find imaginary roots to quadratic equations by applying the quadratic formula.

### Test Version Generation Criteria

A test version generation module, such as stored instructions operating on a machine, automatically generates version(s) of a test based on test version generation criteria that specify how to create a version of a test using the stored test content. The test version generation criteria may be received as user input via a test version generation interface; alternatively or additionally, the test version generation criteria may be retrieved from a test version generation criteria repository, which may be combined with or separate from the test content repository. The test version generation module may be triggered by an application or user request to generate test versions and may not require any other information beyond the test content and the test version generation criteria, each of which may already be stored electronically when the request is received.

Different versions of a test may be generated based on the test version generation criteria. Different versions are versions that have at least one different question or at least two of the same questions in a different order. Different questions may differ in part or in whole, and a question may be defined by compatible parts or as a whole question. Example question parts include a question stem, which prompts the test participant for target information, and question choices, which provide the test participant with options for providing the target information. A question may be lacking a question stem if the target information is clear from other part(s) of the question. Similarly, a question may be lacking choice(s) if the question prompts the test participant for the target information in the form of a short answer, an essay, a recording, a drawing, a diagram, a model, a proof, a code sequence, or any other information to be provided by the test participant.

The different versions of the test may test the same topic(s) and, if so, may test same or different concept(s) within the topic(s). Alternatively, the different versions may test different topics or different concept(s) within the same topic(s). Different versions of a test may be administered to different test participants, who may perform the same or differently individually or in the aggregate among different groups. For example, a first group of test participants who took a first version of a test may average higher than a second group of test participants who took a second version of the test even though the different versions may test the same topic(s) and/or concept(s). Alternatively, different versions of the test may be administered to same test participants such that test participant(s) take multiple versions of the same test. Test participant(s), individually or in the aggregate, may perform the same or differently on different versions of the test. For example, test participants may, on average, perform better on a first version of the test than on a second version of the test even if the test participants took both versions of the test and even if the different versions test the same topic(s) and/or concept(s).

### Assigning Test Versions

A test version assignment module may assign different versions of a test to different test participants based on test version assignment criteria, which may be stored in a test version assignment criteria repository, which may be combined with or separate from the test content repository and/or the test version generation criteria repository. The test version assignment module may be triggered by an application or user request to assign test version(s) to test participant(s) and may not require any other information beyond the test version(s) and the test version assignment criteria, each of which may already be stored electronically when the request is received. The test version(s) may be stored in the test content repository or generated on-the-fly by the test version generation module using the test version generation criteria.

### Analyzing Responses

A response analysis module may analyze responses by test participants to generate test results individually or in the aggregate among groups of participants. For example, individuals may receive a score or a grade on a version of the test, and the response analysis module may generate test-specific statistics such as whether test participants performed better on a first version of a test or a second version of a test, question-specific statistics such as whether test participants performed better on a first version of a question or a second version of a question, or question-part-specific statistics such as whether test participants performed better on a first version of a question part or a second version of a question part. The response analysis module may present the results on a results interface that may be displayed to an administrator or designer of the test content and/or test version generation criteria.

The test version generation module may then automatically add/include, remove/exclude, and/or modify questions, question parts, or other test content based on the results. For example, questions or question parts that show a high degree of variance in responses may be excluded from new versions. The test version assignment module may also automatically modify test assignments based on the results. For example, questions or question parts that show a high degree of variance between groups may be excluded from versions presented to groups that performed poorly on the questions or question parts.

Alternatively, the administrator or designer of test content may add/include, remove/exclude, and/or modify questions, question parts, or other test content based on the results. For example, the designer may rewrite questions that showed a high degree of variance in responses. The administrator may also automatically modify test assignments based on the results. For example, the administrator may modify the test version assignment criteria such that questions or question parts are not assigned to groups that, in the past, performed poorly on the questions or question parts. Interchangeable questions or question parts may already be available or may be developed for those groups.

### Test Version Generation and Assignment System

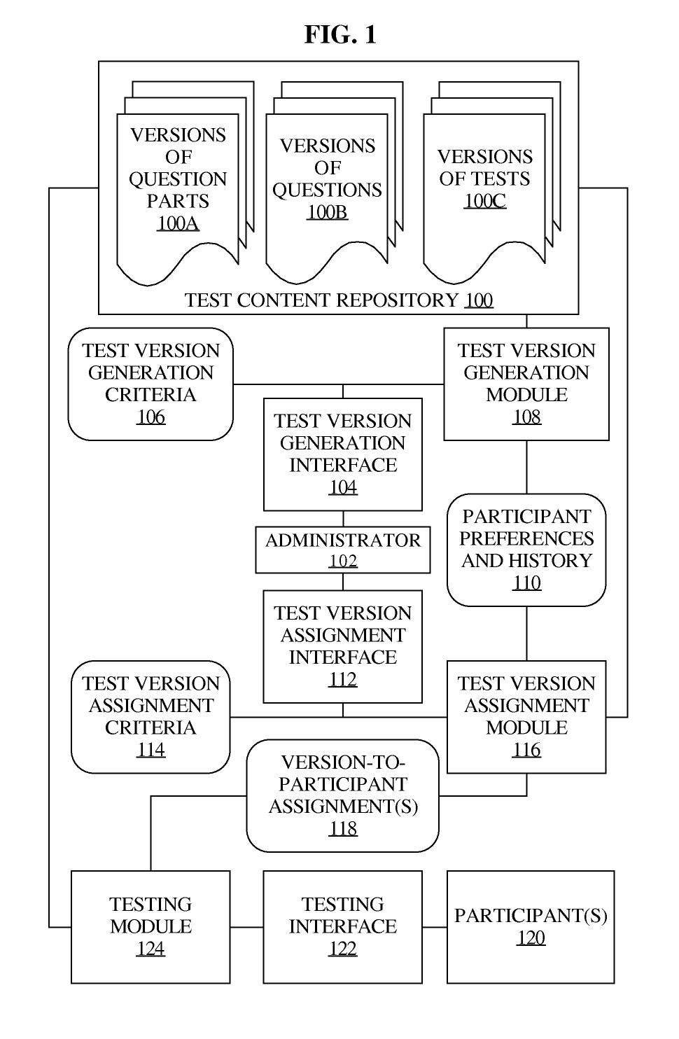

FIG. 1 illustrates an example system for automatically generating versions of a test and automatically assigning the versions to participants. As shown, test content repository 100 includes versions of question parts 100A, questions 100B, and tests 100C. An administrator 102 may interact with a test version generation interface 104, such as a graphical user interface or an application programming interface, to specify test version generation criteria 106 that is applied by test version generation module 108 when test version generation module 108 automatically creates test versions. Test version generation interface 104 may be any interface that receives information from an application or user to add, modify, or remove items of test version generation criteria 106, and test version generation criteria 106 may be specified in any format that identifies what factors should contribute, and optionally how much those factors should contribute, to weighing or filtering versions of question parts, questions, or tests, or in any format that specifies desired distributions of different versions of question parts, questions, or tests among the generated test versions.

Test version generation module applies test version generation criteria 106 to select test content from content repository 100, thereby creating a test version that may be retained in test content repository 100. Test version generation criteria 106 may be based on participant preferences and history 110 for candidate participants that may take the versions that are then generated by the test version generation module 108. Thus, test version generation module 108 may access these participant preferences and history 110 when generating test versions by applying test version generation criteria 106. For example, questions that are heavier in math concepts may be selected for test version(s) if the candidate students include math students. As another example, question parts for which participants have historically performed well may be selected over question parts for which participants have historically underperformed.

Administrator 102 may also interact with a test version assignment interface 112, such as a graphical user interface or an application programming interface, to specify test version assignment criteria 114 that is applied by test version assignment module 116 when test version assignment module 116 automatically assigns test versions to participants. Test version assignment interface 112 may be any interface that receives information from an application or user to add, modify, or remove items of test version assignment criteria 114, and test version assignment criteria 114 may be specified in any format that identifies what factors should contribute, and optionally how much those factors should contribute, to weighing or filtering versions of question parts, questions, or tests when assigning those versions to participants, or in any format that specifies desired distributions of different versions of question parts, questions, or tests among students.

Test version assignment criteria 114 may be based on participant preferences and history 110 for candidate participants that may take the versions that are assigned by the test version assignment module 116. Thus, test version assignment module 116 may access these participant preferences and history 110 when assigning test version to participants by applying test version assignment criteria 114. For example, questions that are heavier in math concepts may be assigned to students who have a background in math. As another example, question parts for which students in a group have historically performed well may be assigned to students in that group; whereas, other question parts for which students in other groups have historically performed well may be assigned to students in the other groups.

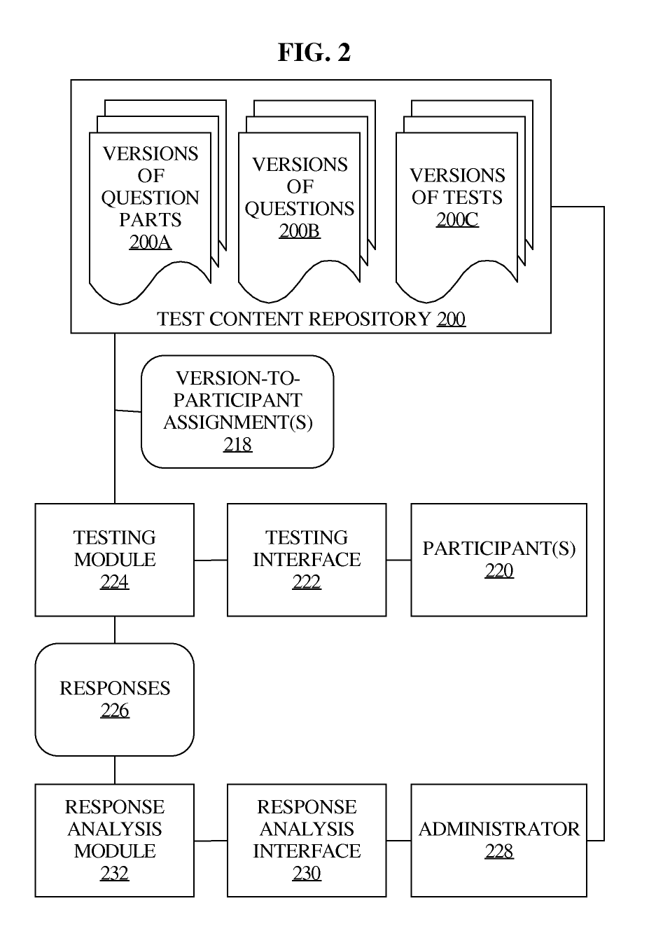

Test version assignment module may generate a mapping between test versions and participants, or version-to-participant assignment(s) 118. Participant(s) 120 may then interact with testing interface 122, such as a graphical user interface or an application programming interface, to submit answers or responses to test questions that were assigned to participant(s) 120. Testing interface 122 may report the responses to testing module 124, which may then update participant preferences and history 110 or provide responses to a response analysis module for further processing, as shown in FIG. 2.

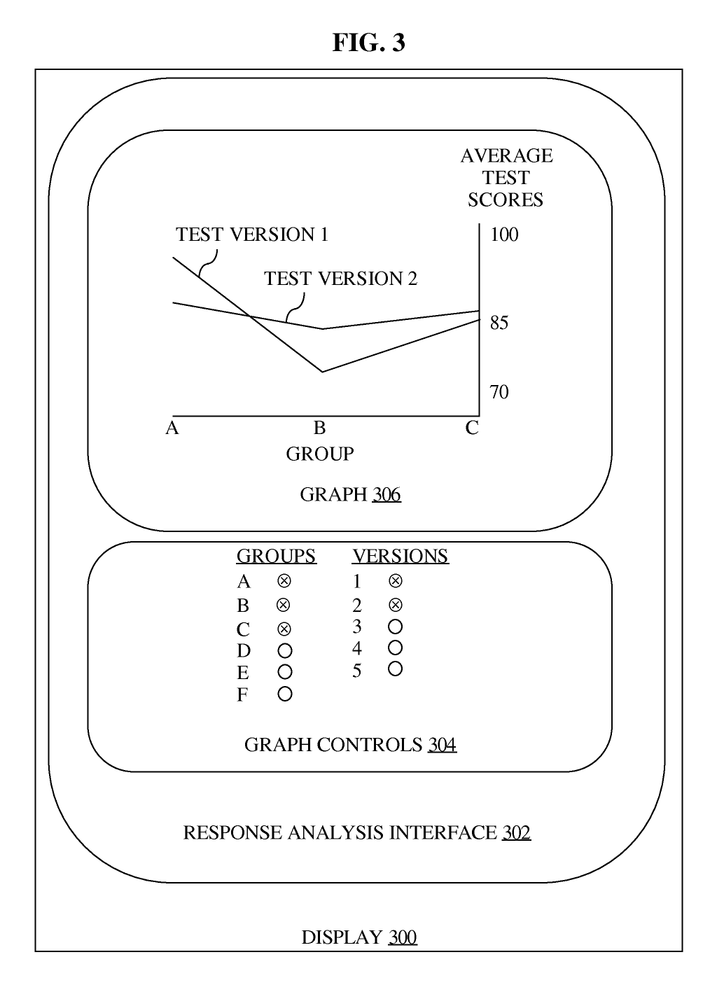

FIG. 2 illustrates an example system for automatically assigning versions of a test to participants and analyzing participant responses on the versions of the test. As shown, testing module 224 sends responses 226 to response analysis module 232. Administrator 228 may then interact with response analysis interface 230, such as a graphical user interface or an application programming interface, to analyze responses. Response analysis interface 230 may be any interface that receives information from an application or user to retrieve, process, or analyze items of responses 226. For example, response analysis interface 230 may display information about students responses from different groups of students and for different versions of a test, as shown in FIG. 3.

Tests may be generated, assigned and administered periodically in a course to test certain concepts. For example, students may be given a quiz each week during an 8-week course, and the students may also be given a mid-term near the middle of the course and a final exam near the end of the course.

The test version generation module, test version assignment module, testing module, and/or response analysis module, as well as the corresponding interfaces, may operate together in an integrated manner or separately in a dependent or independent manner. These modules may operate as running process(es) on computing device(s), or may be stored in one or more non-transitory storage media as instructions that run the process(es) when executed by computing device(s).

### Generating Different Versions of a Test

In one embodiment, computing device(s) operating a combination of hardware and software, such as a test version generation module, store information that includes test questions and test version generation criteria. Each of the test questions may test concept(s) for topic(s). The test version generation criteria defines interchangeable questions, for example, by indicating test concept(s) shared by the questions, by indicating a question identifier shared by the questions, or by otherwise associating the questions with a set of interchangeable questions. The computing device(s) automatically determine, using the test version generation criteria, subsets of test questions that differ from each other by at least one question. The different subsets may test the same topic(s) or may otherwise define interchangeable but distinct versions of a test.

Once the subsets have been generated, each subset can be administered as a different version of the same test. The administration of the test may be manual, or the computing device(s) may cause automatic administration of the test. In the case of automatic administration, the computing devices may cause administration of a first version or form of a test on the topic(s) to first test participant(s). The computing device(s) or other computing device(s), such as devices with access to the subsets of test questions or to the stored information, whether or not such devices are owned, operated, or controlled by a same entity, may also cause administration of other version(s) or form(s) of the test on the topic(s) to other test participant(s). The different versions or forms include questions from respective different subsets of questions and differ from each other by at least one question.

### Interchangeable Question Sets

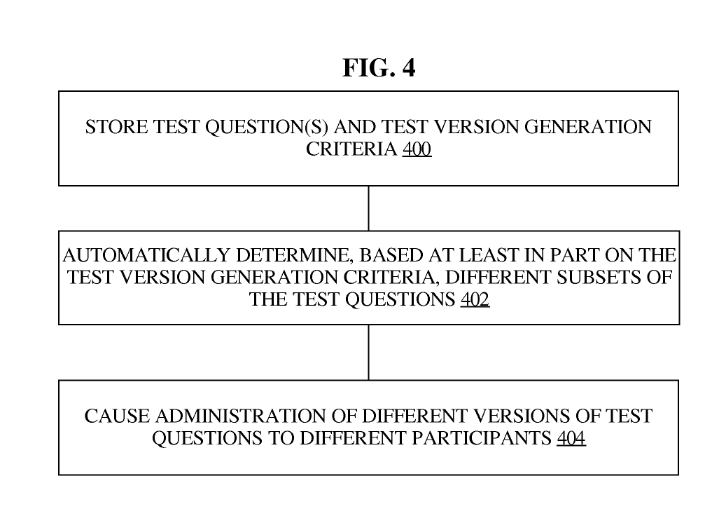

FIG. 4 illustrates an example process for automatically determining different subsets of test questions. As shown, in step 400, computing device(s) operate to store test question(s) and test version generation criteria. Then, in step 402, the computing device(s) automatically determine, based at least in part on the test version generation criteria, different subsets of the test questions. The computing device(s) may then, in step 404, cause administration of different versions of test questions to different participants.

The stored test version generation criteria, when used by a test version generation module, provides some variability such that multiple different combinations of versions of a test may be generated in a manner that satisfies the test version assignment criteria, even though a single combination of versions of the test is generated to preserve randomness or to reach goals specified in the test version generation criteria.

In one embodiment, the test version generation module uses the test version generation criteria to determine group(s) of interchangeable test questions or question parts. Such groups are referred to herein as “interchangeable question sets”. If there are multiple questions that vary from test version to test version, then the test version generation module may determine multiple separate groups of interchangeable test questions or question parts. For example, each group may be associated with a question identifier. Each interchangeable question set may include at least one question or question part that appears in a first version of the test but not in a second version of the test, and at least one other question or question part that appears in the second version but not in the first version. In one embodiment, questions or question parts in the same interchangeable question set test the same concept(s) and/or topic(s), and are designed to have the same difficulty level. In alternative embodiments, questions or question parts in the same interchangeable question set have different difficulty levels.

In one example, a particular interchangeable question set includes a first question comprising a first part and a second part and a second question comprising the first part and a third part that is different from the first part. For example, the first part may be a common question stem, and the second and third parts may be different question choices. As another example, the first part may be a question choice, and the second and third parts may be different question stems. Two different versions of a test may differ by having either the first question or the second question.

Different test versions may be stored in association with a shared virtual test identifier and different version identifiers. For example, “math123test.a” and “math123test.b” may be two different versions for the virtual test, “math123test.” The versions may be named accordingly, or the identifiers may appear in metadata stored in association with the versions, which may have different names.

### Test Templates

In one embodiment, the test version generation criteria comprise test template(s) that identify group(s) of interchangeable test questions and optionally identify test question(s) that occur in every version of the test. The test template(s) may be stored in association with virtual test identifier(s), and the test templates may reference virtual question identifier(s). Question templates may be stored in association with the virtual question identifier(s) and may define alternative or interchangeable versions of the question. For example, a test template, T1, may specify that the test includes Q1, Q2, Q3, and Q4. The question templates for Q1, Q2, and Q3 may specify a single question without any variations. The question template for Q4 may specify possible variations of a question.

For example, the question template for Q4 may delineate the versions using marked up text or variables. In one example using a markup language such as XML, a template for Q4 may be: “<Q4><V1> What are the roots of x²−4?</V1><V2> What are the roots of x²−9?</V2></Q4>,” which specifies versions V1 and V2 of question Q4. The marked up data for question versions, such as Q4, may be provided in same or different document(s) as marked up data for question part versions and/or marked up data for test versions. In the example, a question identifier may identify or reference the question using the label, “Q4,” or a path to the label, such as “MATH/101/MIDTERM/Q4,” which may define a topic or course context in which the question is used.

The test template(s) may include entire questions in-line with logic that identifies the questions to be included and which of the questions are interchangeable, or the test template(s) may reference question identifiers that are defined in question templates, which may or may not be included within the test template(s) but are not necessarily in-line with the specification of which questions are to be included in the test.

### Selecting Test Questions for Test Participants

Automatically determining subset(s) of test questions to be administered to test participant(s) may be performed in response to or based at least in part on a request for test(s) or test version(s). The request for test(s) or test version(s) may specify parameters or criteria for generating the test(s) or test version(s), or may reference stored parameters or criteria for generating the test(s) or test version(s). The test version generation criteria may specify which questions are interchangeable and which questions, if any, are to be included in every version of the test. The test version generation criteria is used by the test version generation module to generate test versions that satisfy or are based on the test version generation criteria.

In one embodiment, the test version generation criteria may specify one or more of several possible techniques for selecting from among a variety of test questions or question parts. Example techniques include a round-robin technique, a weighted technique, a weighted round-robin technique, and/or a random-selection technique. The round-robin technique and random-selection technique may result in an approximately even distribution of questions or question parts across different test versions; whereas the weighted techniques may skew the assignment by preferring some questions or question parts over others for particular test versions.

Determining subsets of questions using the random-selection technique may include randomly selecting versions of test(s), question(s), or question part(s) until the number of possible different versions have been exhausted or until the required number of versions have been determined, optionally ensuring that the randomly selected versions result in different versions of tests. The random-selection technique may be performed based on test version generation criteria that specifies which test, question, or question-part versions should be included within the set of possible versions to use when determining the subsets of test questions.

Determining subsets of questions using the round-robin technique may include selecting from different versions of test(s), question(s), or question part(s) until the number of possible different versions have been exhausted or until the requested number of versions have been determined. The versions may also be assigned to participants using a round-robin technique.

### Weighted Round-Robin Test Version Generation

A weighted round-robin version generation technique may use the round-robin version generation technique, except that different versions of questions or question parts may be used multiple times before cycling through the versions again. For example, the weighted round-robin technique may enforce ratios other than 1:1, such as 2:1 (i.e., a first question version gets used in two test versions for each one test version that uses a second question version) or 2:3 (i.e., a first question version gets used in two test versions for each three test versions that use a second question version).

The weighted technique is based on a weight of a test version, question version, or question part version. The weight indicates how frequently the test version, question version, or question part version should be selected from among other test versions, question version, or question part versions, such as other interchangeable versions. If a version is selected on-the-fly as a participant requests to take a test, the weight may be specified to vary based on characteristics of the participant. For example, a participant who prefers visual questions may receive a question that includes an image or graph, and a different participant who prefers questions to be formulated in mathematical terms may receive a question that includes an equation.

The weight may also vary based on time. For example, an administrator may request that tests are generated such that a first three versions are tested in January and a second three versions are tested in February. The different versions may have different date periods corresponding to when the different versions are valid or when the different should be more heavily weighted. In one embodiment, the test version generation criteria excludes versions from being selected, for example during a given period of time, rather than merely increasing or decreasing the probability that those versions are selected.

### Course Offering and Choice Level Metadata Used in Test Version Generation

In one embodiment, the test version generation criteria is based on metadata about courses of the students for which the test versions are being generated. For example, course offering metadata may specify which question version(s) or test version(s) to use or prefer for a particular course offering, and the test version generation module may generate test versions such that the preferred question version(s) or test version(s) are generated and available to use for the students in the particular course offering.

The test version generation criteria may also include choice-level metadata, which may describe how choices in a question should be varied, how many choices should be included, and/or whether responses should be provided as multiple-choice, short answer, fill-in-the-blank, long answer or essay. Using the choice-level metadata, the test version generation module may vary question choices when generating different test versions, whether or not the question stems are also varied.

### Compatible/Paired Questions

The test version generation criteria may specify information about which questions are compatible with or should be paired with each other. In one example, questions may have question types or characteristics, and questions of the same types or sharing certain characteristics may be grouped together in a version of a test. Questions of other types or sharing other characteristics may be grouped together in other versions of the test.

Example question types or characteristics may include questions with images, multiple choice questions with 2 (such as true/false questions), 3, 4, 5, or more options, word problems, long questions, short questions, short answer questions, fill-in-the-blank questions, essays, mathematically or logically written questions, questions with more than one correct answer, trick questions or questions with double negatives, or questions that require the participant to create virtual or physical models. In another example, questions may be grouped together to promote a diversity of question types or questions that have a diversity of characteristics. In the example, the test version generation module may generate a test version to promote a mixture of long questions and short questions and/or a mixture of fill-in-the-blank questions, short answer questions, and multiple choice questions. The desired portion of each type of question may be specified by an administrator in a request to generate test versions.

In one example, a question bank has several questions, and an IDD or course administrator may want to try variation(s) of one particular question to determine if the variation(s) produce similar results among students. The IDD defines two or more versions of the same question and ties these versions together using metadata provided as input to test version generation interface. For example, the metadata may group the questions into an interchangeable question set. As another example, the metadata may specify which topic(s) and concept(s) are tested by a question such that questions testing similar topic(s) and concept(s) may be interchangeable with each other when creating a test version. The created test version may be created to test certain concepts, but to only include a certain number of questions that are relevant to each concept among the tested concepts. In one example, the metadata may indicate that the only difference between two different versions is the question stem or the choices for a particular question. In another example, multiple questions or question parts may vary from version to version.

### Question Identifiers

In yet another example, rather than or in addition to relying on specified concept(s) or topic(s), question identifier(s) may be referenced in a template for the test. Different versions of a question may be assigned to a same question identifier, which may be referenced by the template. In other words, the template may specify that one version of the question should be included in the test, without specifying which version of the question to include. The test version generation module may then generate different versions of a test by selecting different versions of the identified question.

### Test Version Generation Criteria Example

For random and/or even distribution, the IDD may specify via input received by a test version generation interface, that the test should include multiple versions of the same question without specifying a preference for one version over another version. For non-random distribution, the IDD may specify a preference for one version over another version. For example, the IDD may specify that a first version of the question should appear in 75% of the tests, and that a second version of the question should appear in 25% of the tests. The test version generation module may preserve the distribution by including the first version of the question in 75% of the generated test versions. However, the IDD may request a number of test versions that is not evenly divisible by the specified percentage to which the question should be assigned. Therefore, alternatively, even if the question appears in greater or fewer than 75% of the generated test versions, the generated test versions may be assigned to groups of students with a preference for preserving the specified percentage to which the question should be assigned. For example, if only two versions of the test are created, a version of the test with the first question may be assigned to three times as many students as a version of the test with the second question, thereby preserving the specified percentage (75%) for the first version of the question.

### Participant Characteristics Used in Test Version Generation

The preference for one version over another version may also be based on participant characteristics. For example, a first version could be assigned to students in a first group, and a second version could be assigned to students in a second group. If the first group is larger than the second group, then the first version of the question may appear in more tests than the second version of the question. The distribution may be based on the type of course to which the question is relevant. For example, the IDD may specify via the test version generation interface that version A goes to Math 101 students 75% of the time and Econ 101 students 25% of the time. After the students take the versions of the test, the IDD may evaluate how well the different types or groups of students performed on the different versions of the question.

For questions with the same types of stems or the same types of choices, the IDD may expect, based on the historical data, the same types of variation among different students on different quizzes. The IDD may determine whether students get better over time at answering certain types of questions by exposing those types of questions to different students at different levels or times in the course.

### Test Generation Example

In one example, the question bank includes 60 questions testing 10 concepts, and the IDD requests 20 questions per test version. The 60 questions may be grouped into interchangeable question sets based on concept, and the test version generation module may select randomly from each group to generate a requested number of test versions. The IDD can choose how many questions to use in the test and how many versions of the test to generate. The number of variations may be configurable such that different versions or forms of the test are generated based on the different questions and metadata about those questions.

The request for test(s) or test version(s) may be separate from and independent of a request to administer a test or test version to a particular test participant. If the request for test(s) or test version(s) is received before a request to administer a test or test version to a particular test participant, subset(s) of test questions may be stored, optionally in association with test participant(s). In this embodiment, a subset of test questions may later be retrieved from storage in response to the request to administer the test or test version to the particular test participant.

In another embodiment, the request for test(s) or test version(s) may be combined with or dependent on a request to administer a test or test version to a particular test participant. In this embodiment, the subset of questions may be automatically determined on-the-fly when the test participant is ready to take the test or test version.

In one embodiment, determining the different subsets of test questions may include determining metadata that describes ordering constraint(s) and/or format(s) to be imposed on the different subsets of test questions. In one example, the metadata is stored in association with the selected subsets of questions to define test versions that are ready to be generated and administered to test participants. Alternatively, the metadata may be used by the test version generation module to generate the test versions to be administered to test participants, and the metadata may be retained or discarded once the versions have been generated in the specified format(s) and/or with the specified ordering constraint(s).

### Question Difficulty

If the IDD knows that one set of questions is more difficult than other sets of questions, then that set of questions may be rated as more difficult. Difficulty may be automatically tracked and updated based on test results by participants for different question versions, versions of question parts, and/or for different test versions. The test version generation module may account for question difficulty when generating test versions. For example, the test version generation module may generate tests to promote diversity in question difficulty, mixing easy questions with difficult questions, or to generate test versions of different levels of difficulty, such as preferring easy questions for one test version and difficult questions for another test version.

### Assigning Different Test Versions to Different Test Participants

Whether different subsets of test questions are determined on-the-fly or retrieved from storage, the different subsets of test questions may be assigned to test participants either on-the-fly as the test participant requests to take a test or according to a mapping that is defined before the test participant requests to take the test. The mapping between test participants and test versions may be stored and later retrieved when a test participant requests to take an exam. On the other hand, if the test versions are assigned on-the-fly, the mapping between a test version and a test participant may be determined or generated in response to a request from the test participant to take the test. Whether the mapping is generated on-the-fly or retrieved from storage, generation of the mapping may be automatically performed based on stored test version assignment criteria.

The stored test version assignment criteria, when used by a test version assignment module, provides some variability such that a given student may be assigned any one of multiple versions of a test in a manner that satisfies the test version assignment criteria, even though the student is assigned a single version of the test to preserve randomness or to reach distribution goals specified in the test version assignment criteria.

In one embodiment, computing device(s) operating a combination of hardware and software, such as a test version assignment module, store information that includes test questions and test version assignment criteria. Each of the test questions may test concept(s) for topic(s). The test version assignment criteria are based at least in part on characteristic(s) of participants, at least one of which may vary among at least two different test participants. The computing device(s) automatically assign, using the test version assignment criteria, subsets of test questions, which differ from each other by at least one question, to different test participants. The computing device(s) then cause administration of a first version or form of a test on the topic(s) to first test participant(s). The computing device(s) or other computing device(s), such as devices with access to the subsets of test questions or to the stored information, whether or not such devices are owned, operated, or controlled by a same entity, may also cause administration of other version(s) or form(s) of the test on the topic(s) to other test participant(s). The different versions or forms include questions from respective different subsets of questions and differ from each other by at least one question.

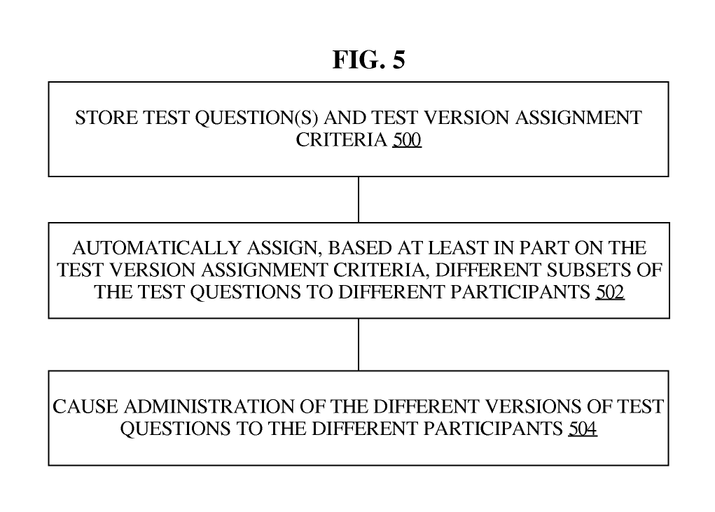

FIG. 5 illustrates an example process for automatically assigning different subsets of test questions to different participants. As shown, in step 500, computing device(s) operate to store test question(s) and test version assignment criteria. Then, in step 502, the computing device(s) automatically assign, based at least in part on the test version assignment criteria, different subsets of the test questions to different participants. The computing device(s) may then, in step 504, cause administration of different versions of test questions to different participants.

The test version assignment module may receive a request for a test, such as a test on a particular topic, to be administered to a test participant. A test version or the subset of questions therein may be automatically assigned, based at least in part on the test version assignment criteria, in response to the request. Also, administration of the assigned test version to the test participant may be caused, for example on a testing interface, in response to the request.

The test version assignment module may receive a request to assign two or more different versions of the test to different test participants, optionally well before administration of the test. The different versions or the different subsets of questions therein are assigned, based at least in part on the one or more test version assignment criteria, in response to the request. After the different subsets are assigned, a testing module receives a request for the test to be administered to a test participant. The testing module may cause administration of the version of the test assigned to the test participant, for example on a testing interface, in response to a separate request for the test to be administered to the participant.

The test version assignment module may store test result information that describes test results of test participants. For example, the test result information may identify, for each individual instance of each individual version of the test that was administered to an individual test participant: the individual test participant, the individual version of the test, and a quantitative result for at least one question that differs among different versions of the test that were administered to different test participants.

### Test Version Assignment Criteria

The test version assignment criteria may define different target distributions of different test versions among different test participants based at least in part on a participant characteristic that varies among different test participants. Alternatively or additionally, the test version assignment criteria may define different target distributions of different question versions or question part versions among different test participants based at least in part on a participant characteristic that varies among the different test participants. In an example, the test version assignment criteria may define, for a first version of a test, question or question part, a target distribution of 25% of a first group of participants and 75% of a second group of participants, and, for a second version of the test, question, or question part, a target distribution of 75% of the first group and 25% of the second group. The first group may be defined as those students who are taking a math class, and the second group may be defined as those students who are taking an economics class. In the example, students in the first group are characterized as math students, and students in the second group are characterized as economics students. Although the students may be taking different courses or focusing on different areas of study, the test given to the different groups of students may test the same topic and optionally even the same concept(s) within the topic. For example, the economics students and math students may both be learning about differential equations.

The test version assignment criteria used to assign a version to a participant may include user history, user profile, and certain metadata that the IDD provides. The test version assignment criteria may be different from the test version generation criteria or rules/heuristics to select the set of questions. The test version assignment criteria defines how the versions should be distributed among students. For example, the test version assignment criteria may specify to evenly distribute the available versions across the set of students, or use the metadata or other context information to pick a particular version. The metadata may include the difficulty or weight of the version, characteristics of the participant, and/or other metadata that the IDD defines.

The test version assignment module may assign test versions based on course-level information, group-level information, or participant-level information. For example, at the course-level, the test version assignment module may assign versions to attain a desired distribution among the students of different courses. For example, 75% of students in one course may receive version 1, and 75% of students in another course may receive version 2, with or without regard to information about students or groups of students.

Groups may be defined regionally, for example, according to which instructor is assigned to students in the group, according to discussion sections, or according to background or characteristics shared by students in the group. At the group-level, the test version assignment module may assign versions to attain a desired distribution among the students in the different groups. For example, 75% of students in one group may receive version 1, and 75% of students in another group may receive version 2, with or without regard to information about students or courses to which those students belong. For study groups or discussion sections, group-level assignment may ensure that students in same groups get same or different versions.

At the participant-level, the test version assignment module uses information about individual participants to assign versions to participants. Assignment may be done when a participant attempts to start a test or beforehand for candidate participants of the test. For example, the test version assignment module may account for participant preferences; past performance by the participant on similar questions, question parts, tests, concepts, or topics; or the overall performance of the participant on other questions, similar or not. For example, a participant may explicitly indicate, via input to a preferences interface, that the participant prefers pictures over textual content. In other words, a student may know that he or she is better at visualizing topics rather than at reading comprehension. Based on this preference, the test version assignment module may increase a probability that the participant receives questions with pictures rather than questions with long textual descriptions. In this manner, the test versions may be personalized for the participant.

In one embodiment, test versions are generated before any participants take the test versions, and test versions are assigned at the time the participants request to take a test. In this embodiment, the test version assignment module may account for personalized preferences that may be specified by the participant at the time the participant requests to take the test.

### Participant Characteristics Used in Test Version Assignment

The participant characteristics may include group(s) or course(s) to which participant(s) belong, have taken, or with which participant(s) are otherwise associated. The group(s) or course(s) may include group(s) or course(s) that are stored in association with some test participant(s) but not other test participant(s) of a body of test participants taking a test. In the example above, some students may be associated with an economics group, others with a math group, and possibly others not with any group at all.

Alternatively or additionally, the participant characteristics may include historical information about test question(s). The test question(s) may include test question(s) that were logged as being previously supplied to some test participant(s) but not other test participant(s) of a body of test participants taking a test. The test question(s) in the historical information may share characteristics with or otherwise be similar to candidate test question(s) that may appear in different versions of a test. For example, if a student did poorly on a past question that shares characteristics with a candidate question, then the test version assignment module may decrease a probability that the candidate question is assigned to the student. Conversely, the test version assignment module may increase a probability that a candidate question is assigned to a student if the student did well on similar question(s) in the past. The test version generation module may alternatively or additionally decrease a probability that the question appears in test versions if candidate test participants did poorly on similar questions in the past or did better on different questions in the past. Conversely, the test version generation module may increase a probability that the question appears in test versions if candidate test participants did well on similar questions in the past or did poorly on different questions in the past.

Alternatively or additionally, the participant characteristics may include preference(s) of test participant(s). The preference(s) may include preference(s) of some test participant(s) but not other test participant(s) of a body of test participants taking a test. The preferences may be for certain types of questions or certain types of formatting. For example, a first student may prefer questions with pictures or graphs, and a second student may prefer questions with equations or with mathematical or logical operators. The test version assignment module may increase a probability that the first student receives questions with pictures or graphs and a probability that the second student receives questions with equations or mathematical or logical operators. Conversely, the test version assignment module may decrease a probability that either student receives non-preferred types of questions. The test version generation module may alternatively or additionally increase a probability that certain types of questions appear in versions of the test if candidate test participants prefer those types of questions. Conversely, the test version generation module may decrease a probability that non-preferred types of questions appear in test versions.

### Using the Test Version Assignment Criteria to Make Version-to-Participant Assignments

In one embodiment, the test version generation module generates different versions of a test, and all of the versions of the test may be assigned the same virtual test identifier and a different version identifier. The test version assignment module may then receive a request to assign version(s) of a test to student(s), and the request may identify the test using the virtual test identifier. For example, a syllabus for a course may include a link that identifies or references the virtual test identifier, and the test version assignment module may, upon receiving a selection of the link by a student, cause assignment of a version of the identified test to the student. Alternatively, the request may identify the test using identifiers for concept(s) and/or topic(s) that are covered by the test, and the link may identify or reference the concept(s) and/or topic(s). Based on the request, the test version assignment module may assign version(s) identified by the virtual test identifier and/or identifier(s) for the concept(s) and/or topic(s). Assignments may be determined at the time of testing or beforehand. The testing module may administer different versions of the test according to the assignments determined by the test version assignment module.

Different techniques may be used to assign participants to versions of a test, question, or question part based on the test version assignment criteria. Example techniques include a round-robin technique, a weighted technique, a weighted round-robin technique, and a random-selection technique. The round-robin technique and random-selection technique may result in approximately even assignments across students having different characteristics or in different groups; whereas the weighted techniques may skew the assignment by preferring some students over others for particular versions. Assigning subsets of questions using the round-robin technique may include selecting from existing and eligible versions of test(s), question(s), or question part(s) until the existing and eligible versions have been assigned or until the requested number of versions has been assigned to participants or until all identified participants have been assigned to a version. If the existing and eligible versions have been assigned to at least one student, the test version assignment module may cycle through those versions again by assigning them to second students, third students, and so on, until the requested number of versions have been assigned to participants or until all identified participants have been assigned to a version. The test versions may also be generated using a round-robin technique to select questions or question parts.

Assigning subsets of questions using the random-selection technique may include randomly selecting from existing and eligible versions of test(s), question(s), or question part(s) until the requested number of versions has been assigned to participants or until all identified participants have been assigned to a version. If the existing and eligible versions have been assigned to at least one student, the test version assignment module may continue assigning those versions to second students, third students, and so on, until the requested number of versions have been assigned to participants or until all identified participants have been assigned to a version. The test versions may also be generated using a random-selection technique to select questions or question parts.

A weighted assignment technique weighs versions based on various factors or based on weights specified by the IDD. Instead of equally assigning versions to participants, the weighted assignment technique may increase or decrease a probability that one version is assigned to particular participants, otherwise preserving a randomness to the assignment. Alternatively, a weighted round-robin assignment technique may use the round-robin assignment technique, except that different versions of a test may be assigned multiple times before cycling through the versions again. For example, the weighted round-robin technique may enforce ratios other than 1:1, such as 2:1 (i.e., a first version gets assigned to two participants for each one participant assigned to the second version) or 2:3 (i.e., a first version gets assigned to two participants for each three participants assigned to the second version). The test versions may also be generated using a weighted technique or weighted round-robin technique to select questions or question parts.

### Maintaining Stored Versions of Tests

The test version generation module may store each version of a test, question, or question part in association with a test, question, or question part identifier and a version identifier. Other metadata may also be stored on a version-by-version basis. For example, a version of a test, question, or question part may be stored in association with information that identifies the weight of a version, dates or time period during which the version should be effective or preferred, the difficulty level of the version, user groups and preferences relevant to the version, and/or specific course offerings relevant to the version.

The weight of a version may define how preferred the version is over other versions, and the weight may be considered as a factor for selecting, by the test version generation module, which versions of questions or question parts to include within test versions. The weight may alternatively or additionally be considered as a factor for determining which test versions should be assigned to test participants, and/or how frequently those test versions should be assigned, by the test version assignment module.

The dates or time period during which the version should be effective or preferred may define when the version should be considered at all, and, if considered, the weight of the version during that time period. The time period may be considered as a factor for selecting, by the test version generation module, which versions of questions or question parts to include within test versions at various times. The time period may alternatively or additionally be considered as a factor for determining which test versions should be assigned to test participants, and/or how frequently those test versions should be assigned, by the test version assignment module at various times.

A difficulty level of a version may be determined automatically based on historical information about performance of test participants on the version. Alternatively, the difficulty level may be specified manually by an IDD. The difficulty level may be considered as a factor for selecting, by the test version generation module, which versions of questions or question parts to include within test versions. For example, the test version generation module may balance a test version by selecting a mixture of difficult questions and easy questions. As another example, the test version generation module may generate test versions with different levels of difficulty by preferring difficult questions for a difficult test version and easy questions for an easier test version. The difficulty level may alternatively or additionally be considered as a factor for determining which test versions should be assigned to test participants, and/or how frequently those test versions should be assigned, by the test version assignment module. For example, the test version assignment module may select easier tests or tests with easier questions for students who are struggling on a particular concept or topic and more difficult tests or tests with more difficult questions for students who are performing well on the particular concept or topic.

User groups for a version may define which groups of participants are eligible for, preferred for, or excluded from the version. The user groups may be considered as a factor for selecting, by the test version generation module, which versions of questions or question parts to include within test versions. For example, a first version of a test may be eligible only for students with a background in certain math courses, and a second version of the test may be eligible only for students with a background in certain economics courses. Alternatively, the versions may be preferred for the respective groups or excluded from the respective groups. The user groups may alternatively or additionally be considered as a factor for determining which test versions should be assigned to test participants, and/or how frequently those test versions should be assigned, by the test version assignment module. For example, the test version assignment module may select math-heavy tests or tests with high-level math questions for math students and economics-heavy tests or tests with high-level economics questions for economics students.

### Administering Test Versions and Analyzing Responses

Once a participant requesting to take an exam has been mapped to a version of the exam, which includes some questions but not other questions from a question bank, a testing interface may cause the mapped-to version of the exam to be administered to the test participant. For example, the testing interface may present the assigned subset of questions, including question stems and optionally response choices, on a display, and the subset of questions may be presented sequentially, concurrently, on a scrollable page, on swipe-able or linked pages, or in any other manner that allows the participant to answer questions for the version of the test. Administration of the test version to the test participant may be caused at a same or different time, dependently or independently of when the test version is generated and/or when the test version is assigned to the test participant.

In one embodiment, after test participant(s) have taken test version(s), a response analysis module stores test result information that identifies, for each individual instance of each individual version of the test that was administered to an individual test participant: the individual test participant, the individual version of the test, and a quantitative result for at least one question that differs among at least two different versions of the test that were administered to at least two different test participants.

For example, a first student, A, may have taken a first instance of a first version, V1, of a test; a second student, B, may have taken a second instance of the first version, V1, of the test; and a third student, C, may have taken a first instance of a second version, V2, of the test. Responses by students A, B, and C may be analyzed to determine quantitative results, such as scores, of the students on the test versions. For example, student A may have answered 90% of the questions correctly; student B may have answered 80% of the questions correctly; and student C may have answered 95% of the questions correctly. These results may be compared to determine that students A and B both incorrectly answered a first version of a question, Q1A, on version V1, but student C correctly answered a second version of a question, Q1B, on version V2.

In the example, Q1A and Q1B may test same concept(s) and/or topic(s) and may even be defined as interchangeable questions on the test. As more results are gathered for the test, an administrator may determine based on the results that one of the versions of the question, either Q1A or Q1B, does not accurately test the concept(s) or topic(s) associated with the question version. For example, the question may be too easy or too difficult, may be confusingly worded, may contain answer choices or a question stem that gives away the correct answer, or may contain answer choices or a question stem that is inconsistent with the correct answer.

The test result information may be stored in association with test participants, groups of participants, courses, relevant concepts or topics, test versions, question versions, or question part versions. The test result information may be specific to instances of the test that were taken, questions within the instances, or even parts of the question, and may include statistics for individuals, specific groups, or for all students. The stored information may be organized to reveal progress among individuals, groups, or all students on particular concept(s) or topic(s).

Information about the responses may be displayed to an administrator or designer organized by student, group of students, concept, question, question part, or question type. For example, a results interface may present, to an administrator, a chart or other view of data about the performance of a student for each concept covered in a course. Concepts covered at different times in a course may be referred to as concept levels, especially when these concepts build off of each other, and performance with respect to these concepts may be charted over time. The interface may highlight, on the chart, inflection points, local maxima, local minima, or significant changes in performance for the student. The highlighted concepts may be targeted in future tests by increasing or decreasing an amount of questions or a difficulty of questions for those concepts, optionally depending on whether those concepts are core concepts to a course.

FIG. 3 illustrates an example interface for analyzing responses of participants on versions of a test. As shown, the interface causes display, on display 300, of response analysis interface 302, which includes graph controls 304 and graph 306. Graph controls 304 are user-configurable controls for selecting what information should appear on graph 306. Graph 306 includes information about different groups of participants and different versions of tests. As shown, average test scores are being compared for the different groups (A, B, and C) and different versions (1 and 2). In other examples, graph 306 or some other representation of information may present information specific to different versions of questions or question parts within a test, information generalized by course, topic or concept, or information, and/or information specific to individual students within a course. Graph 306 may also present information in terms of time, such as when different tests were taken by participants.

### Evaluating Test Content

Information about past test participant performance on versions of a test, questions in the test, or parts of questions in the test may be used to predict how same or different test participants will perform in the future. These predictions may be used to flag certain parts of questions, certain questions, or certain versions of a test as potentially troublesome for a group of future test participants. Information about past performance may also be used to vary test content, to vary the test version generation criteria for generating new test versions, and to vary the test version assignment criteria for generating new assignments from versions to participants.

Information about different tests may contribute to the test version generation criteria and/or the test version assignment criteria for a given test. For example, information about how well a student performed on a certain type of question may be used to determine whether or not to assign questions of a similar type to the student, even if the performance data is from tests on different topic(s) or concept(s). Example question types may be defined based on the grammar used to form the question, the type of response allowed (i.e., multiple choice, true/false, fill-in-the-blank, short answer, or essay), or the length or complexity of the question.

The IDD may evaluate a question using the results interface to determine whether performance data about the question is meaningful or valid. For example, the results interface may show that more than 50% of the students answered a question incorrectly, and, based on this information, the IDD may come up with a hypothesis about why the students answered this question incorrectly. The IDD may hypothesize that the question would be answered correctly more frequently if the question stem was improved to be clearer, if the choices were modified to be clearer, or if questions were more carefully tailored to the background of the students. For example, the test may have been offered as part of an introductory math or economics course, and the test may be math-heavy. As a result, complex mathematical questions may have been answered correctly more frequently by students with a math background than students with an economics background or students without a math background.

### Predicting Participant Performance and Evaluating Prediction

An example hypothesis by the IDD may be that the grammar used to form a question is positively or negatively affecting the end result of the question. To prove this hypothesis, the IDD may request, via a test version generation interface, variations of the question such that the variations use different question stems or different grammar. In other words, the variations or different versions of the question ask for the same information in a different way. The test version generation module may generate two versions of the question that appear in two different versions of the test, and these different versions of the test may be given to a new body of students to test the IDD's hypothesis.

The response analysis module may categorize or organize different participant results into different buckets, with the different buckets corresponding to different versions. The response analysis interface may display the different results so that the IDD can then confirm or reject his or her hypothesis. If results significantly improve after a variation to the question stem or question grammar, then the IDD may conclude that the question stem or grammar was at least partially a cause of the poor performance in the prior test(s), confirming his or her hypothesis. On the other hand, if results do not significantly improve after the variation, then the IDD may conclude that the question stem or grammar was not a primary cause of the poor performance in the prior test(s), rejecting his or her hypothesis.

### Updating Test Content and/or Criteria

If, based on the participant responses on test versions, a version of a test, question, or question part appears to be well-understood by the participants and appears to accurately test target concept(s), as compared with other version(s), then the version may be given more weight than other versions. Alternatively, if the version appears to be misunderstood by the participants or appears to poorly test the target concept(s), as compared with other version(s), then the version may be given less weight than other versions. In one embodiment, the response analysis module may automatically vary version weights based on statistics about participant responses on the versions. For example, versions having average scores that are outliers from other versions, either significantly higher or lower, may be automatically given a decreased weight for future administrations of the test.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

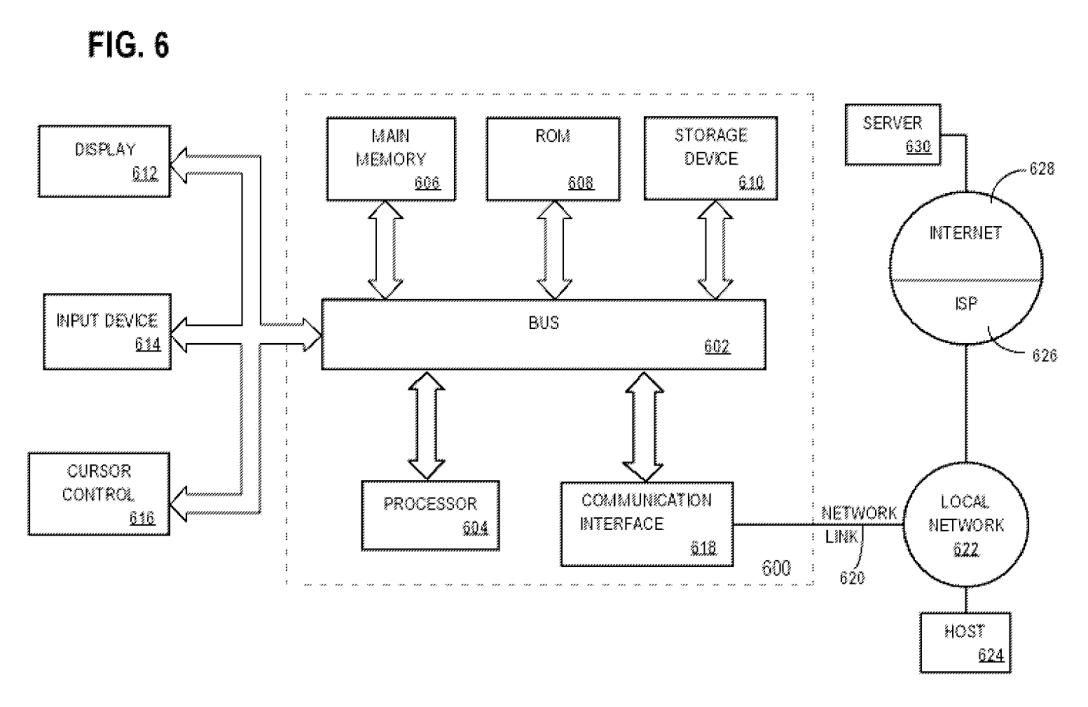

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing information comprising:
a plurality of test questions, each test question of the plurality of test questions testing one or more topics,
one or more test version generation criteria; and
data that establishes an interchangeable question set that includes at least two interchangeable questions;
automatically determining, based at least in part on the one or more test version generation criteria and the interchangeable question set, different subsets of the plurality of questions;
wherein the different subsets include a first subset and a second subset;
wherein the first subset includes at least one question that differs from any question in the second subset;
causing administration of a first version of a test on the one or more topics to a first test participant of a plurality of test participants, the first version including the first subset but not said at least one question from the second subset;
wherein a second version of the test on the one or more topics is caused to be administered to a second test participant of the plurality of test participants, the second version including the second subset but not said at least one question from the first subset;
wherein the method is performed by one or more computing devices.

2. The method of claim 1, further comprising receiving a request for the test on the one or more topics to be administered to the first test participant; wherein both the step of automatically determining, and the step of causing administration, are performed in response to the request.

3. The method of claim 1, further comprising:
receiving a request to generate two or more different versions of the test on the one or more topics; and
wherein the different subsets are determined in response to the request.

4. The method of claim 1, wherein:
at least a first test question and a second test question of the plurality of test questions belong to the interchangeable question set;
the first test question is in the first subset but not in the second subset, and
the second test question is in the second subset but not in the first subset.

5. The method of claim 4, wherein the first test question comprises a first part and a second part, and wherein the second test question comprises the first part and a third part, wherein the third part is different than the second part.

6. The method of claim 5, wherein the first part is a question stem, and wherein the second part and the third part are choices.

7. The method of claim 5, wherein the first part is a question choice, and wherein the second part and the third part are question stems.

8. The method of claim 1, wherein the one or more test version generation criteria comprise one or more test templates that identify:
one or more interchangeable test question sets; and
one or more test questions that occur in every version of the test.

9. The method of claim 1, further comprising locating the first version of the test based at least in part on a virtual identifier of the test, wherein the second version of the test is also associated with the virtual identifier.

10. A method comprising:
storing information comprising:
a plurality of test questions, each test question of the plurality of test questions testing one or more topics, and
one or more test version assignment criteria, wherein the one or more test version assignment criteria are based at least in part on one or more participant characteristics, wherein at least one of the one or more participant characteristics varies among at least two different test participants of a plurality of test participants;
automatically assigning, based at least in part on the one or more test version assignment criteria, different subsets of the plurality of test questions to different test participants, of the plurality of test participants;
wherein the different participants include a first test participant and a second test participant;
wherein automatically assigning includes assigning a first subset to the first participant and assigning a second subset to the second participant;
wherein the first subset includes at least one question that differs from any question in the second subset;
causing administration of a first version of a test on the one or more topics to the first test participant, the first version including the first subset but not said at least one question from the second subset;
wherein a second version of the test on the one or more topics is caused to be administered to the second test participant, the second version including the second subset but not said at least one question from the first subset;
wherein the first version of the test comprises the first subset of the plurality of test questions but not at least one question from the second subset of the plurality of test questions; and
wherein the second version of the test comprises the second subset of the plurality of test questions but not at least one question from the first subset of the plurality of test questions;
wherein the method is performed by one or more computing devices.

11. The method of claim 10, further comprising:
receiving a request for the test on the one or more topics to be administered to the first test participant;
wherein both the step of automatically assigning and the step of causing administration are performed in response to the request.

12. The method of claim 10, wherein the one or more test version assignment criteria defines a first target distribution of the first subset to a first group of test participants that share one or more participant characteristics that differ from one or more participant characteristics shared by a second group of test participants to which a second target distribution of the first subset is applied, wherein the second target distribution is different than the first target distribution.

13. The method of claim 10, wherein the one or more test version assignment criteria defines a first target distribution of the first subset to a group of test participants and a second target distribution of the second subset to the group of test participants.

14. The method of claim 10, wherein automatically assigning comprises, for at least a particular test participant, weighing the different subsets based at least in part on a particular participant characteristic of the particular test participant; wherein one or more other participant characteristics are weighed differently than the particular participant characteristic.

15. The method of claim 10, wherein the one or more test version assignment criteria define different target distributions of different test versions among different test participants based at least in part on the at least one participant characteristic that varies among at least two different test participants, wherein the different test versions test the one or more topics.

16. The method of claim 10, wherein the one or more test version assignment criteria define different target distributions of different question versions among different test participants based at least in part on the at least one participant characteristic that varies among at least two different test participants, wherein the different question versions test a same one or more concepts for the one or more topics.

17. The method of claim 10, wherein the one or more participant characteristics comprise one or more different groups or courses to which at least some different test participants of the plurality of test participants belong.

18. The method of claim 10, wherein the one or more participant characteristics comprise historical information about participant performance on one or more test questions, wherein at least one test question of the one or more test questions was logged as being previously supplied to one or more test participants of the plurality of test participants but not to one or more other test participants of the plurality of test participants.

19. The method of claim 10, wherein the one or more participant characteristics comprise one or more preferences, wherein at least one of the one or more preferences was specified by and stored in association with one or more test participants of the plurality of test participants but not one or more other test participants of the plurality of test participants.

20. The method of claim 10, further comprising locating the first version of the test based at least in part on a virtual identifier of the test, wherein the second version of the test is also associated with the virtual identifier.

21. One or more non-transitory computer-readable storage media storing instructions, which, when executed, cause performance of the method recited in claim 1.

22. One or more non-transitory computer-readable storage media storing instructions, which, when executed, cause performance of the method recited in claim 9.
